(19) United States
(12) Patent Application Publication
(10) Pub. No.: US 2025/0066638 A1
(43) Pub. Date: Feb. 27, 2025

(54) DUCTILE MATERIAL, METHOD FOR MANUFACTURING DUCTILE MEMBER, AND ANTI-COLLISION DEVICE FOR BRIDGE PIERS

(71) Applicants: SHANDONG UNIVERSITY, Jinan, Shandong (CN); SHANDONG TRAFFIC ENGINEERING SUPERVISION CONSULTING CO., LTD., Jinan, Shandong (CN)

(72) Inventors: Zeying YANG, Jinan (CN); Kang DUAN, Jinan (CN); Qingshui GAO, Jinan (CN); Rongrong DUAN, Jinan (CN); Hongyun WANG, Jinan (CN); Xinxue GAO, Jinan (CN); Chuanhao SHAN, Weifang (CN); Weisong QU, Jinan (CN); Qianyi YANG, Jinan (CN); Xue ZHANG, Jinan (CN); Yingyong LI, Jinan (CN); Jianbo QU, Jinan (CN); Lingjian GUO, Jinan (CN); Kaikai MA, Jinan (CN); Feng ZHAO, Jinan (CN); Rongxiao SUN, Jinan (CN); Zhilin QU, Jinan (CN); Rui SUN, Jinan (CN); Chuanlong BI, Jinan (CN); Chenghe WANG, Jinan (CN)

(73) Assignees: SHANDONG UNIVERSITY, Jinan, Shandong (CN); SHANDONG TRAFFIC ENGINEERING SUPERVISION CONSULTING CO., LTD., Jinan, Shandong (CN)

(21) Appl. No.: 18/292,016

(22) PCT Filed: May 5, 2023
(86) PCT No.: PCT/CN2023/092341

§ 371 Date: Jan. 25, 2024

(30) Foreign Application Priority Data
Mar. 17, 2023 (CN) 202310280512.7

(51) Int. Cl. C09D 175/04; B29C 64/153; B29K 75/00; B29K 505/08; B29K 505/12; B29L 31/00; B33Y 10/00; B33Y 80/00; C09D 7/61; C09D 7/80; E01D 19/02

(52) U.S. Cl. CPC C09D 175/04; B29C 64/153; B33Y 10/00; B33Y 80/00; C09D 7/61; C09D 7/80; E01D 19/02; B29K 2075/00; B29K 2505/08; B29K 2505/12; B29K 2995/0008; B29L 2031/768

(57) ABSTRACT

A ductile material, a method for manufacturing a ductile member, and an anti-collision device for bridge piers, wherein the ductile material includes specific components in parts by mass as follows: 50-62 parts of thermoplastic polyurethane, 11-33 parts of neodymium-iron-boron, 12-24 parts of nickel-titanium alloy, 2-3 parts of metal magnetic powder, and 1-2 parts of polypropylene or polyethylene or polylactic acid or polyetheretherketone. The use of the ductile material, the method for manufacturing a ductile member, and the anti-collision device for bridge piers facilitates navigation.

The present invention claims priority to Chinese Patent Application No. 202310280512.7, filed with the China National Intellectual Property Administration on Mar. 17, 2023 and entitled “DUCTILE MATERIAL, METHOD FOR MANUFACTURING DUCTILE MEMBER, AND ANTI-COLLISION DEVICE FOR BRIDGE PIERS”, which is incorporated herein by reference in its entirety.

### TECHNICAL FIELD

The present invention relates to the field of anti-collision technologies for bridge piers, and specifically, to a ductile material, a method for manufacturing a ductile member, and an anti-collision device for bridge piers.

### BACKGROUND

The statements herein provide only the background related to the present invention, but do not necessarily constitute the related art.

With the production of more and more over-water bridges, the impact of floating objects in water on bridge piers in water causes damage to the structure of the bridge piers, which seriously affects the service life of the bridges. Providing an effective anti-collision protection facility for the bridge piers in water can not only reduce the impact of the floating objects in water, such as floating ice and ships, on the bridge piers, but also effectively protect the structure of the bridge piers and increase the service life of the bridge piers, and facilitate the detection on damage to the bridge piers.

It was found that materials for a target anti-collision device for bridge piers cannot be used for implementing a ductile function, and consequently the anti-collision device cannot contract or expand. The anti-collision device needs to be manufactured into a structure with a large diameter to ensure the anti-collision performance, and consequently the distance between adjacent bridge piers is reduced, which is not conducive to navigation. The patent CN105839568B discloses an active head-on collision device for bridge piers and an anti-collision method, by which the bridge piers can contract and expand, but requires an electromagnetic telescopic device and a corresponding control system, leading to high production costs.

### SUMMARY

In view of the deficiencies in the related art, an objective of the present invention is to provide a ductile material that can expand when passing objects are about to collide with bridge piers to ensure a protective effect and can contract in a natural state to facilitate navigation. In addition, the ductile material can contract and expand when used on bridge piers without a complex control system, which reduces costs for manufacturing an anti-collision device for bridge piers.

To achieve the foregoing objective, the present invention provides the following technical solutions:

According to a first aspect, an embodiment of the present invention provides a ductile material, including specific components in parts by mass as follows: 50-62 parts of thermoplastic polyurethane, 11-33 parts of neodymium-iron-boron, 12-24 parts of nickel-titanium alloy, 2-3 parts of metal magnetic powder, and 1-2 parts of polypropylene or polyethylene or polylactic acid or polyetheretherketone.

According to a second aspect, an embodiment of the present invention provides a method for manufacturing a ductile member, where the ductile member is made of the ductile material according to the first aspect, and the method includes:
mixing 50-62 parts of thermoplastic polyurethane powder, 11-33 parts of neodymium-iron-boron powder, 12-24 parts of nickel-titanium alloy powder, 2-3 parts of metal magnetic powder, and 1-2 parts of polypropylene powder or polyethylene powder or polylactic acid powder or polyetheretherketone powder in parts by mass, to obtain composite powder;
drying the composite powder; and
performing laser 3D printing with dried composite powder to form the ductile member.

Optionally, the thermoplastic polyurethane powder is provided in a density of 0.4-0.6 g/cm³, preferably 0.5 g/cm³.

Optionally, the neodymium-iron-boron powder is isotropic bonded neodymium-iron-boron powder.

Optionally, laser 3D printing is performed using an SLS device, with laser power of 100-300 W, preferably 200 W, at a scanning speed of 300-800 mm/s, preferably 600 mm/s, and at a processing temperature of (Tm+5)-(Tm+35° C.), preferably Tm+20° C.

Optionally, the thermoplastic polyurethane powder and the neodymium-iron-boron powder are pre-milled using a ball mill, and then the thermoplastic polyurethane powder, the neodymium-iron-boron powder, the nickel-titanium alloy powder, the metal magnetic powder, and the polypropylene or polyethylene or polylactic acid powder are mixed.

Optionally, milling time is 15-25 min, preferably 20 min, and a rotational speed for powder mixing of the ball mill is 750-800 r/min, preferably 775 r/min.

Optionally, the composite powder is dried using a drying oven, at a drying temperature of 65-75° C., preferably 70° C., for drying time of 45-50 h, preferably 48 h.

According to a third aspect, an embodiment of the present invention provides an anti-collision device for bridge piers, including a plurality of ductile members, where the ductile member is manufactured by using the method for manufacturing a ductile member according to the second aspect, the plurality of ductile members are arranged on a periphery of a bridge pier in a circular direction, inner ends thereof are connected to the bridge pier, outer ends thereof are connected to a load-bearing member with a cavity inside, the load-bearing member is provided with a plurality of expansion joints in the circular direction, and hollow rubber balls are provided inside the load-bearing member.

Optionally, the load-bearing member is made of a superhydrophobic aluminum alloy.

The present invention has the following beneficial effects:
1. Neodymium-iron-boron is added in the ductile material and the ductile member manufactured therefrom in the present invention. Neodymium-iron-boron, as a functional factor, provides magnetic properties for composite materials. When the ductile member is used on the anti-collision device for bridge piers, the ductile member can expand based on the magnetic principle when a passing vehicle or ship is close to the anti-collision device for bridge piers, to drive the anti-collision device for bridge piers to expand, which has a good anti-collision effect. In addition, the ductile member can contract in a natural state, which does not affect navigation between adjacent bridge piers. Moreover, the ductile member can expand and contract based on material characteristics without the mounting of a complex control system and a related electrically-controlled telescopic part, thereby reducing production costs.
2. A nickel-titanium alloy is added in the ductile material and the ductile member manufactured therefrom in the present invention, which can significantly improve an anti-pressure capability of the anti-collision device manufactured therefrom, thereby improving anti-collision performance.

### BRIEF DESCRIPTION OF THE DRAWINGS

The accompanying drawings of this specification that constitute a part of the present invention are used to provide a further understanding of the present invention. Exemplary embodiments of the present invention and descriptions thereof are used to explain the present invention, and do not constitute any inappropriate limitation to the present invention.

FIG. 1 is a flowchart of a method for manufacturing a ductile member according to Example 1 or Example 2 or Example 3 of the present invention;

FIG. 2 is a top view of an anti-collision device for bridge piers in a natural state according to Example 4 of the present invention;

FIG. 3 is a side view of an anti-collision device for bridge piers in a natural state according to Example 4 of the present invention;

FIG. 4 is an axonometric drawing of an anti-collision device for bridge piers in a natural state according to Example 4 of the present invention; and

FIG. 5 is a top view of an anti-collision device for bridge piers in an anti-collision state according to Example 3 of the present invention.

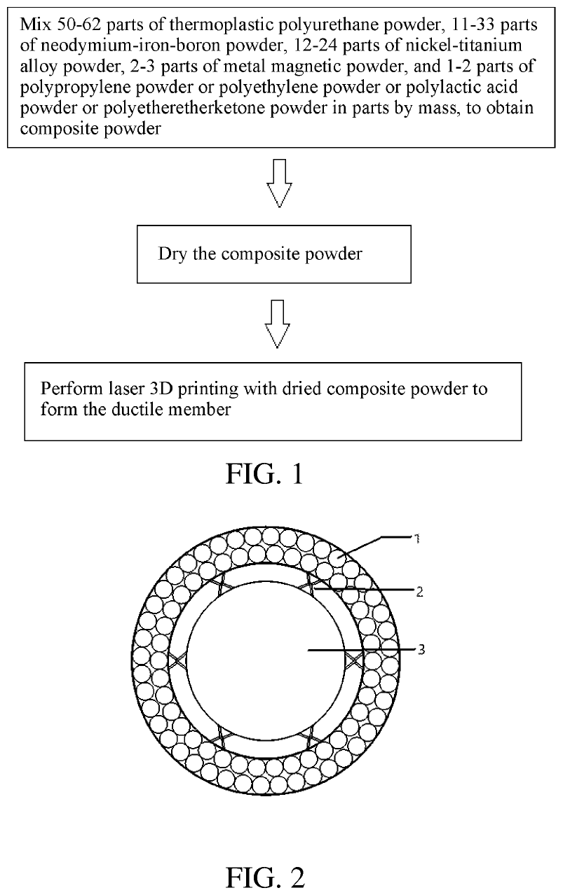

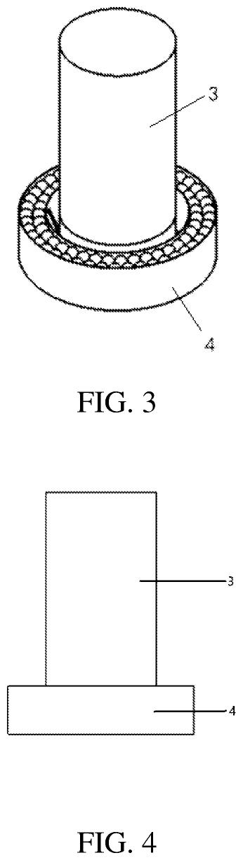

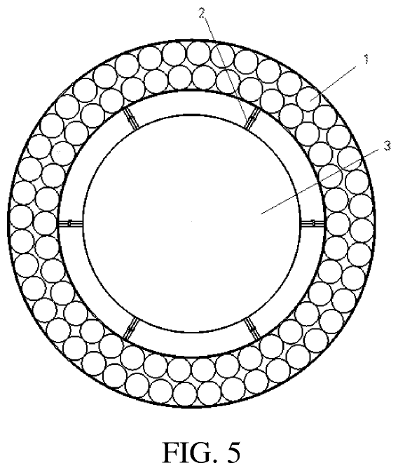

In the figures, 1—Hollow rubber ball, 2—Ductile member, 3—Bridge pier, and 4—Outer annular plate.

### DETAILED DESCRIPTION

In an exemplary implementation of this application, a ductile material includes specific components in parts by mass as follows: 50-62 parts of thermoplastic polyurethane, 11-33 parts of neodymium-iron-boron, 12-24 parts of nickel-titanium alloy, 2-3 parts of metal magnetic powder, and 1-2 parts of polypropylene or polyethylene or polylactic acid or polyetheretherketone.

Neodymium-iron-boron is added in the ductile material in this implementation. Neodymium-iron-boron, as a functional factor, provides magnetic properties for composite materials. When the ductile member is used on the anti-collision device for bridge piers, the ductile member can expand based on the magnetic principle when a passing vehicle or ship is close to the anti-collision device for bridge piers, to drive the anti-collision device for bridge piers to expand, which has a good anti-collision effect. In addition, the ductile member can contract in a natural state, which does not affect navigation between adjacent bridge piers.

The addition of a nickel-titanium alloy can significantly improve an anti-pressure capability of the anti-collision device manufactured therefrom, thereby improving anti-collision performance.

In another exemplary implementation of this application, a method for manufacturing a ductile member is provided. The ductile member is manufactured by using the ductile material in the foregoing implementation. The method includes the following steps:

Step 1: Mix 50-62 parts of thermoplastic polyurethane powder, 11-33 parts of neodymium-iron-boron powder, 12-24 parts of nickel-titanium alloy powder, 2-3 parts of metal magnetic powder, and 1-2 parts of polypropylene powder or polyethylene powder or polylactic acid powder or polyetheretherketone powder in parts by mass, to obtain composite powder.

Step 2: Dry the composite powder.

Step 3: Perform laser 3D printing with dried composite powder to form the ductile member.

Further, the thermoplastic polyurethane powder is provided in a density of 0.4-0.6 g/cm³, preferably 0.5 g/cm³.

Further, the neodymium-iron-boron powder is isotropic bonded neodymium-iron-boron powder, with main magnetic parameters: remanence of 780-790 mT, preferably 787.50 mT, and coercivity of 435-445 KA/m, preferably 440.03 KA/m.

Further, laser 3D printing is performed using an SLS device, with laser power of 100-300 W, preferably 200 W, at a scanning speed of 300-800 mm/s, preferably 600 mm/s, and at a processing temperature of (Tm+5)-(Tm+35° C.), preferably Tm+20° C.

Further, the thermoplastic polyurethane powder and the neodymium-iron-boron powder are pre-milled using a ball mill, and then the thermoplastic polyurethane powder, the neodymium-iron-boron powder, the nickel-titanium alloy powder, the metal magnetic powder, and the polypropylene or polyethylene or polylactic acid powder are mixed.

Further, milling time is 15-25 min, preferably 20 min, and a rotational speed for powder mixing of the ball mill is 750-800 r/min, preferably 775 r/min.

Further, the composite powder is dried using a drying oven, at a drying temperature of 65-75° C., preferably 70° C., for drying time of 45-50 h, preferably 48 h.

The ductile member is of a cross structure in a natural state and includes two V-shaped structures, and the two V-shaped structures intersect at the tips. When it is detected that a ship or vehicle approaches, the two V-shaped structures expand into a straight-line structure under magnetic attraction, thereby implementing the expansion of the ductile member.

To make a person skilled in the art understand the technical solutions of this application more clearly, the following describes the technical solutions of this application in detail with reference to specific examples and comparative examples.

### Example 1

This example provides a ductile member made of a ductile material. The ductile material includes specific components in parts by mass as follows: 60 parts of thermoplastic polyurethane, 12 parts of neodymium-iron-boron, 24 parts of nickel-titanium alloy, 3 parts of metal magnetic powder, and 1 part of polypropylene.

A specific manufacturing method includes the following steps:

Step 1:60 parts of thermoplastic polyurethane powder and 12 parts of neodymium-iron-boron were mixed and milled using a ball mill at 750 r/min for 20 min. The thermoplastic polyurethane powder is provided in a density of 0.5 g/cm³.

The milled powder was taken out and mixed with 24 parts of nickel-titanium alloy powder, 3 parts of metal magnetic powder, and 1 part of polypropylene powder to obtain composite powder. In this example, the metal magnetic powder is iron powder.

Step 2: The composite powder obtained in step 1 was dried in a drying oven at 70° C. for 48 h.

Step 3: Laser 3D printing was performed with the dried composite powder. The specific process is as follows:

The composite powder was added in a powder cylinder of an SLS device, a CO₂ laser beam mirror was wiped clean, a heating device was reset, and a processing environment was enclosed. In view of pre-processing, a powder bed was pre-formed before continuous manufacturing, and pre-processing parameters were set to laser power of 200 W, a scanning speed of 500 mm/s, and a powder layer thickness of 50 μm. A start temperature for pre-forming was set to 115° C., a time interval for pre-forming was set to 20 s, and a thickness of a pre-formed powder bed was set to 2.5 mm. A processing temperature was controlled at 125° C. to make the composite powder formed.

The processing temperature controlled at 125° C. can provide optimal bonding performance of the powder in a radio of 60 parts of thermoplastic polyurethane to 12 parts of neodymium-iron-boron.

In this example, the content of neodymium-iron-boron is 20% of the content of thermoplastic polyurethane. It is found from the study on the ratio of the two materials that the ductile member in this content ratio has relative magnetization intensity of 1.4 mT and can be loaded to maximum stress of 1.2 MPa.

### Example 2

This example provides a ductile member made of a ductile material. The ductile material includes specific components in parts by mass as follows: 60 parts of thermoplastic polyurethane, 20 parts of neodymium-iron-boron, 15 parts of nickel-titanium alloy, 3 parts of metal magnetic powder, and 2 parts of polyethylene.

A specific manufacturing method includes the following steps:

Step 1:60 parts of thermoplastic polyurethane powder and 20 parts of neodymium-iron-boron were mixed and milled using a ball mill at 775 r/min for 20 min. The thermoplastic polyurethane powder is provided in a density of 0.5 g/cm³.

The milled powder was taken out and mixed with 15 parts of nickel-titanium alloy powder, 3 parts of metal magnetic powder, and 2 parts of polyethylene powder to obtain composite powder. In this example, the metal magnetic powder is iron powder.

Step 2: The composite powder obtained in step 1 was dried in a drying oven at 75° C. for 48 h.

Step 3: Laser 3D printing was performed with the dried composite powder. The specific process is as follows:

The composite powder was added in a powder cylinder of an SLS device, a CO₂ laser beam mirror was wiped clean, a heating device was reset, and a processing environment was enclosed. In view of pre-processing, a powder bed was pre-formed before continuous manufacturing, and pre-processing parameters were set to laser power of 200 W, a scanning speed of 800 mm/s, and a powder layer thickness of 50 μm. A start temperature for pre-forming was set to 115° C., a time interval for pre-forming was set to 20 s, and a thickness of a pre-formed powder bed was set to 2.5 mm. A processing temperature was controlled at 128° C. to make the composite powder formed.

The processing temperature controlled at 128° C. can provide optimal bonding performance of the powder in a radio of 60 parts of thermoplastic polyurethane to 20 parts of neodymium-iron-boron.

In this example, the content of neodymium-iron-boron is 30% of the content of thermoplastic polyurethane. It is found from the study on the ratio of the two materials that the ductile member in this content ratio has relative magnetization intensity of 2.5 mT and can be loaded to maximum stress of 3 MPa.

### Example 3

This example provides a ductile member made of a ductile material. The ductile material includes specific components in parts by mass as follows: 55 parts of thermoplastic polyurethane, 22 parts of neodymium-iron-boron, 20 parts of nickel-titanium alloy, 2 parts of metal magnetic powder, and 1 part of polyethylene.

A specific manufacturing method includes the following steps:

Step 1:55 parts of thermoplastic polyurethane powder and 22 parts of neodymium-iron-boron were mixed and milled using a ball mill at 700 r/min for 20 min. The thermoplastic polyurethane powder is provided in a density of 0.5 g/cm³.

The milled powder was taken out and mixed with 20 parts of nickel-titanium alloy powder, 2 parts of metal magnetic powder, and 1 part of polyethylene powder to obtain composite powder. In this example, the metal magnetic powder is iron powder.

Step 2: The composite powder obtained in step 1 was dried in a drying oven at 75° C. for 48 h.

Step 3: Laser 3D printing was performed with the dried composite powder. The specific process is as follows:

The composite powder was added in a powder cylinder of an SLS device, a CO₂ laser beam mirror was wiped clean, a heating device was reset, and a processing environment was enclosed. In view of pre-processing, a powder bed was pre-formed before continuous manufacturing, and pre-processing parameters were set to laser power of 300 W, a scanning speed of 800 mm/s, and a powder layer thickness of 50 μm. A start temperature for pre-forming was set to 115° C., a time interval for pre-forming was set to 20 s, and a thickness of a pre-formed powder bed was set to 2.5 mm. A processing temperature was controlled at 130° C. to make the composite powder formed.

The processing temperature controlled at 130° C. can provide optimal bonding performance of the powder in a radio of 55 parts of thermoplastic polyurethane to 22 parts of neodymium-iron-boron.

In this example, the content of neodymium-iron-boron is 40% of the content of thermoplastic polyurethane. It is found from the study on the ratio of the two materials that the ductile member in this content ratio has relative magnetization intensity of 5 mT and can be loaded to maximum stress of 1.4 MPa.

The addition of a nickel-titanium alloy can significantly improve an anti-pressure capability of the anti-collision device manufactured therefrom, thereby improving anti-collision performance. An existing anti-collision material for bridge piers has compressive strength of 150-250 MPa and elasticity modulus of 6.9-17 MPa. The ductile member in this example has compressive strength of 400-420 MPa and elasticity modulus of 54.8±3.7 GPa.

### Example 4

This example provides an anti-collision device for bridge piers, including a plurality of ductile members 2 manufactured in Example 1 or Example 2 or Example 3. The ductile member 2 is of a cross structure in a natural state and includes two V-shaped structures, and the two V-shaped structures intersect at the tips. When it is detected that a ship or vehicle approaches, the two V-shaped structures expand into a straight-line structure under magnetic attraction, thereby implementing the expansion of the ductile member.

The ductile members are arranged on a periphery of a bridge pier 3. Inner ends of the two V-shaped structures are connected to a mounting plate on the periphery of the bridge pier 3. The mounting plate of the bridge pier is provided with a sliding groove. The inner ends of the two V-shaped structures extend into the sliding groove and are slidably connected to the mounting plate. Outer ends of the two V-shaped structures are slidably connected to an inner side surface of an annular load-bearing member through a sliding groove. The provision of the sliding groove implements expansion and contraction functions of the ductile member.

The load-bearing member includes an inner annular plate and an outer annular plate 4. The outer annular plate 4 is coaxially disposed on a periphery of the inner annular plate. An inner side surface of the inner annular plate is fixed to outer ends of the ductile member 2. A cavity is formed between the inner annular plate and the outer annular plate 4. A plurality of hollow rubber balls 1 arranged in a honeycomb shape are provided in the cavity. The inner side surface of the inner annular plate is provided with a sliding groove for the ends of the ductile member to slide.

The inner annular plate and the outer annular plate 4 are both made of a superhydrophobic aluminum alloy with main components in parts by mass as follows: 97.5 parts of Al, 0.2-0.6 parts of Si, 0.40 parts of Fe, 0.10 parts of Cu, 0.10 parts of Mn, 0.45-0.9 parts of Mg, 0.10 parts of Cr, 0.15 parts of Zn, and 0.15 parts of Ti.

The superhydrophobic aluminum alloy has anti-icing and self-cleaning properties, and enhances corrosion resistance, which can avoid reduction of ductility due to the frozen water surface and the solidification with the device.

Both the inner annular plate and the outer annular plate are provided with a plurality of expansion joints in a circular direction.

A manufacturing method includes the following steps:

Step 1: An aluminum alloy plate containing the foregoing components was sanded by using 800-grit, 1200-grit, and 1500-grit SiC sandpaper in sequence until there are no apparent scratches on the surface, to remove an oxide layer from the surface.

Step 2: The aluminum alloy plate was ultrasonically cleaned with methanol, acetone, and deionized water in sequence to remove grease.

Step 3: The cleaned aluminum alloy plate was soaked in an ethanol/water (1:3 by volume) solution containing 10 mmol/L of stearic acid at 60° C. for 35 h.

The manufactured ductile member 2 and load-bearing member in this example were brought to a mounting site.

On-site drilling was performed according to the actual situation during mounting. First, setting out was appropriately adjusted for locating. The clash with a load-bearing rebar has to be avoided during locating. If there is a clash with a transverse rebar, it is necessary to move the mounting location upward or downward as a whole, to ensure that the drilling hole is located 5-6 cm away from the rebar.

The hole was drilled at the location in a diameter of 20-30 mm and a depth of 300-350 mm. After the drilling was completed, each hole was inspected according to the specification requirements.

The surface of the bridge pier was cleaned and polished before mounting to keep it dry.

An anchoring adhesive was injected into the hole until the design strength was reached, and then the anti-collision device for bridge piers was mounted.

After the adhesive reached the design strength, the mounting plate was fixed on the periphery of the bridge pier using Q345 fully-threaded screws. Then, the ductile member and the load-bearing member were mounted. Two ends of an inner side of the ductile member were slidably connected to the mounting plate through the sliding groove of the mounting plate, and two ends of an outer side of the ductile member were slidably connected to the inner annular plate through the sliding groove of the inner annular plate, to implement expansion and contraction functions of the ductile member.

In this example, six ductile members 2 were provided, and adjacent ductile members were provided at an interval of 60°. The anti-collision device for bridge piers in this example has extremely high application value for small-tonnage ships and small-scale navigable bridges, with high reaction sensitivity, easy maintenance after collision damage, and timely detection and observation of the degree of damage.

The foregoing descriptions are merely preferred examples of this application and are not intended to limit this application. A person skilled in the art may make various modifications and changes of this application. Any modification, equivalent replacement, or improvement made within the spirit and principle of this application shall fall within the protection scope of this application.

1. A ductile material, comprising specific components in parts by mass as follows:
50-62 parts of thermoplastic polyurethane, 11-33 parts of neodymium-iron-boron, 12-24 parts of nickel-titanium alloy, 2-3 parts of metal magnetic powder, and 1-2 parts of polypropylene or polyethylene or polylactic acid or polyetheretherketone.

2. A method for manufacturing a ductile member, wherein the ductile member is made of the ductile material according to claim 1, and the method comprises:
mixing 50-62 parts of thermoplastic polyurethane powder, 11-33 parts of neodymium-iron-boron powder, 12-24 parts of nickel-titanium alloy powder, 2-3 parts of metal magnetic powder, and 1-2 parts of polypropylene powder or polyethylene powder or polylactic acid powder or polyetheretherketone powder in parts by mass, to obtain composite powder; drying the composite powder; and
performing laser 3D printing with dried composite powder to form the ductile member.

3. The method for manufacturing a ductile member according to claim 2, wherein the thermoplastic polyurethane powder is provided in a density of 0.4-0.6 g/cm³.

4. The method for manufacturing a ductile member according to claim 2, wherein the neodymium-iron-boron powder is isotropic bonded neodymium-iron-boron powder.

5. The method for manufacturing a ductile member according to claim 2, wherein laser 3D printing is performed with the composite powder using an SLS device, with laser power of 100-300 W, at a scanning speed of 300-800 mm/s, and at a processing temperature of (Tm+5)-(Tm+35)° C.

6. The method for manufacturing a ductile member according to claim 2, wherein the thermoplastic polyurethane powder and the neodymium-iron-boron powder are pre-milled using a ball mill, and then the thermoplastic polyurethane powder, the neodymium-iron-boron powder, the nickel-titanium alloy powder, the metal magnetic powder, and the polypropylene or polyethylene or polylactic acid powder are mixed.

7. The method for manufacturing a ductile member according to claim 6, wherein milling time is 15-25 min, and a rotational speed for powder mixing of the ball mill is 750-800 r/min.

8. The method for manufacturing a ductile member according to claim 2, wherein the composite powder is dried using a drying oven, at a drying temperature of 65-75° C. for drying time of 45-50 h.

9. An anti-collision device for bridge piers, comprising a plurality of ductile members, wherein the ductile member is manufactured by using the method for manufacturing a ductile member according to claim 2, the plurality of ductile members are arranged on a periphery of a bridge pier in a circular direction, inner ends thereof are connected to the bridge pier, outer ends thereof are connected to a load-bearing member with a cavity inside, the load-bearing member is provided with a plurality of expansion joints in the circular direction, and hollow rubber balls are provided inside the load-bearing member.

10. The anti-collision device for bridge piers according to claim 9, wherein the load-bearing member is made of a superhydrophobic aluminum alloy.
